(19) United States
(12) Patent Application Publication
(10) Pub. No.: US 2010/0192147 A1
(43) Pub. Date: Jul. 29, 2010

(54) METHOD OF INSTALLING SOFTWARE, PROGRAM, AND INFORMATION PROCESSING APPARATUS

(75) Inventor: Masatoshi KADOTA, Takahama-shi (JP)

Correspondence Address: Scully, Scott, Murphy & Presser, P.C., 400 Garden City Plaza, Suite 300, Garden City, NY, 11530, US

(73) Assignee: BROTHER KOGYO KABUSHIKI KAISHA, Aichi-ken (JP)

(21) Appl. No.: 12/695,479

(22) Filed: Jan. 28, 2010

(30) Foreign Application Priority Data
Jan. 28, 2009 (JP) 2009-016829

(51) Int. Cl. G06F 9/445; G06F 21/00

(52) U.S. Cl. 717/178; 717/174; 726/26

(57) ABSTRACT

In an information processing apparatus, when an installation execution instruction is input, a package which is instructed by the execution instruction, and packages which are in a dependence relationship with the package are set as an install items. For each of the packages, a license text indicated by text data in the package is set as a display text for a license dialog. A group of packages having the same license which is to be concluded is detected by comparing display texts which are set in packages, with one another, and, for each group of packages having the same license, a license dialog in which the common display text is described is displayed. In this case, the user is inquired about the intention of agreement conclusion while identification information of packages corresponding to the license is described together with the license which is the display text, in the dialog.

### CROSS REFERENCE TO RELATED APPLICATION

The present application claims priority from Japanese Patent Application No. 2009-016829, which was filed on Jan. 28, 2009, the disclosure of which is incorporated herein by reference in its entirety.

### BACKGROUND OF THE INVENTION

The present invention relates to a method of installing plural pieces of software, and a program and information processing apparatus for installing plural pieces of software.

As a method of installing a software, known is a method in which several dialogs are displayed in steps before the end of an install process to request an installation instruction from the user, and a software is installed in an interactive manner.

As an information processing apparatus which is operated by an operating system such as Linux (registered trademark), an apparatus including a package management utility such as APT is known. In such an information processing apparatus, when an installation execution instruction is input through a user interface, the installation execution instruction, and a designated package are installed into the information processing apparatus by the package management utility, and also a package(s) having a dependence relationship with the designated package is installed.

In an information processing apparatus which is operated by Linux (registered trademark) or the like, in the case where there is package B which is in a dependence relationship with certain package A, a CPU cannot normally execute a process corresponding to the package A unless both the package A and the package B are installed.

The package management utility automatically detects such a package having a dependence relationship, and installs the package or instructs the user to install the package, thereby supporting the installing work by the user.

### SUMMARY OF THE INVENTION

When a software is to be used, usually, the user is requested to obtain approval of a license condition from the provider of the software.

Usually, a license of a software is deemed to be concluded at the moment when the software is used. In order to clarify the fact that an agreement is concluded, a software installation program such as described below has been known. Namely, a license dialog in which a license condition is described, and which includes an input object (operation button) through which the intention to approve the license condition can be input is displayed. When the input object is operated to input the intention to approve the license condition, substantial installation of the software is started.

In the case where plural pieces of software are to be installed in accordance with an installation execution instruction which is input by the user, when such a license dialog is displayed for each of the to-be-installed plural pieces of software, many dialogs are displayed to the user until installation of all of the plural pieces of software are completed. Therefore, the burden of the installing work on the user is large.

Namely, for each of the plural pieces of software, the user must check the license condition which is individually displayed, and perform an operation of approving the license condition through a corresponding dialog.

The invention has been conducted in view of the above-discussed problem. It is an object of the invention to provide a technique for reducing the burden on the user when plural pieces of software are to be installed.

In order to achieve the above object, exemplary embodiments of the present invention provides the following arrangements:

A computer readable recording medium storing a program for causing a computer to perform:

an install item setting procedure for setting plural pieces of software as install items;

an license identifying procedure for identifying a license that must be concluded in a use of the software with respect to each of the plural pieces of software which are set as the install items in the install item setting procedure;

a detection procedure for detecting a software group including pieces of software having the same license to be concluded, from the plural pieces of software which are set as the install items;

a display control procedure for controlling a displaying device to display a first agreement text of the license that is common to the pieces of software in the detected software group; and

an install procedure for installing the pieces of software corresponding to the license in which intention of conclusion is input from an outside.

A computer readable recording medium storing a program for causing a computer to perform:

an install item setting procedure for setting plural pieces of software as install items;

a display control procedure for controlling a displaying device to display a license screen in which an agreement text of a license that must be concluded in a use of each of the pieces of software that are set as the install items in the install item setting procedure is described, the license screen including a collective input object through which intention of collectively concluding licenses of the pieces of software can be input; and

an install procedure for installing the pieces of software which are set as the install items when the intention of collectively concluding licenses is input through the collective input object included in the license screen.

A method of installing plural pieces of software which are set as install items, into an information processing apparatus, the method comprising:

identifying a license that must be concluded in a use of the software with respect to each of the plural pieces of software which are set as the install items;

detecting a software group including pieces of software having the same license to be concluded, from the plural pieces of software which are set as the install items;

controlling a displaying device to display a first agreement text of the license that is common to the pieces of software in the detected software group;

when the pieces of software which are set as the install item include the software which is not included in the detected software group, controlling the display device to display a second agreement text of the license of the piece of software which is set as the install item and is not included in the detected software group; and

installing the pieces of software corresponding to the license in which intention of conclusion is input from an outside.

(4) A method of installing plural pieces of software which are set as an install items, into an information processing apparatus, the method comprising:

controlling a displaying device to display a license screen in which an agreement text of a license that must be concluded in a use of each of the pieces of software that are set as the install items is described, the license screen including a collective input object through which intention of collectively concluding licenses of the pieces of software can be input; and

installing the pieces of software which are set as the install items when the intention of collectively concluding licenses is input through the collective input object included in the license screen.

An information processing apparatus comprising:

an item setting unit which sets plural pieces of software as install items;

an agreement identifying unit which identifies a license that must be concluded in a use of the software with respect to each of the plural pieces of software which are set as the install items;

a detecting unit which detects a software group including pieces of software having the same license to be concluded, from the plural pieces of software which are set as the install items;

a display controlling unit which controls a displaying device to display a first agreement text of the license that is common to the pieces of software in the detected software group, and when the pieces of software which is set as the install item includes the software which is not included in the detected software group, controls the display device to display a second agreement text of the license of the piece of software which is set as the install item and is not included in the detected software group; and an installing unit which installs the pieces of software corresponding to the license in which intention of conclusion is input from an outside in the information processing apparatus.

An information processing apparatus including:

an item setting unit which sets plural pieces of software as install items;

a display controlling unit which controls a displaying device to display a license screen in which an agreement text of a license that must be concluded in a use of each of the pieces of software that are set as the install items is described, the license screen including a collective input object through which intention of collectively concluding licenses of the pieces of software can be input; and

an installing unit which installs the pieces of software which are set as the install items in the information processing apparatus when the intention of collectively concluding licenses is input through the collective input object included in the license screen.

### BRIEF DESCRIPTION OF THE DRAWINGS

FIG. 1 is a block diagram showing the configuration of an information processing apparatus 10 of a first embodiment.

FIGS. 2A and 2B are a flowchart showing an install control process which is executed by a CPU 11.

FIG. 3 is a flowchart showing the install control process which is executed by the CPU 11.

FIGS. 4A and 4B are a flowchart showing the install control process which is executed by the CPU 11.

FIG. 5 is a view illustrating a specific example of an install list.

FIGS. 6A and 6B are a flowchart showing an agreement text display setting process which is executed by the CPU 11.

FIG. 7 is a view showing the configuration of a license dialog which is displayed on a displaying device 23.

FIG. 8 is a flowchart showing an install control process in a second embodiment.

FIG. 9 is a view showing the configuration of a license dialog in the second embodiment.

FIGS. 10A and 10B are a flowchart showing an install control process in a third embodiment.

FIGS. 11A and 11B are a flowchart showing an install control process in a fourth embodiment.

FIG. 12 is a block diagram showing the configuration of a communication system 50 in a fifth embodiment.

FIGS. 13A and 13B are a flowchart showing an install control process in the fifth embodiment.

FIGS. 14A and 14B are a flowchart showing the install control process in the fifth embodiment.

### DESCRIPTION OF EXEMPLARY EMBODIMENTS

Hereinafter, embodiments of the invention will be described with reference to the drawings. It is a matter of course that the invention is not restricted to the embodiments described below, but may be variously embodied.

### First Embodiment

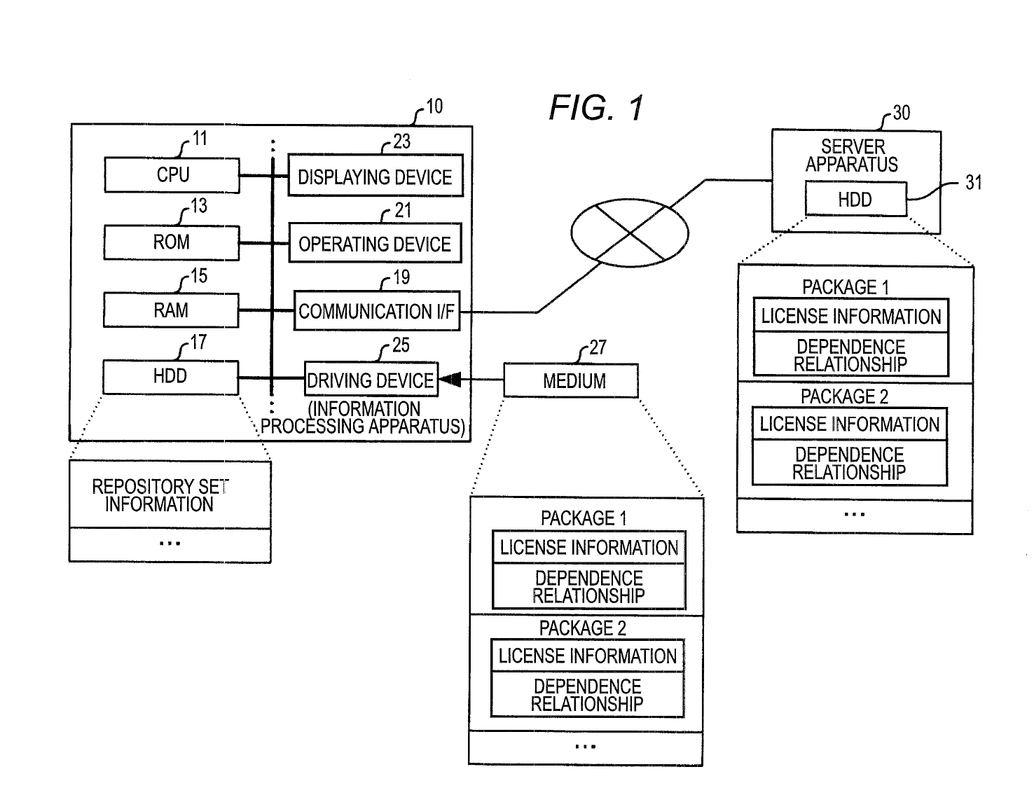

FIG. 1 is a block diagram showing the configuration of an information processing apparatus 10 of a first embodiment. Similarly with a well-known personal computer, the information processing apparatus 10 includes: a CPU 11; a ROM 13; a RAM 15 which is used as a work area during program execution by the CPU 11; a hard disk drive 17 which stores an operating system (OS) and the like; a communication interface 19; an operating device 21 which is configured by a keyboard, a pointing device, and the like; a displaying device 23 which is configured by a liquid crystal displaying device, and the like; and a driving device 25 (for example, a CD-ROM drive) which can read out data from a medium (for example, a CD-ROM) 27.

In the information processing apparatus 10, at start up, the CPU 11 reads the operating system (OS) which is stored in the hard disk drive 17, and, under the operating system, executes a process based on an application software installed in the hard disk drive 17.

The hard disk drive 17 further stores an install utility which is a program for installing an application software. The CPU 11 executes a process based on the install utility to install various pieces of application software into the apparatus (specifically, the hard disk drive 17). In the embodiment, the information processing apparatus 10 is supposed to be operated by Linux (registered trademark), and it is assumed that an application software is provided by a software provider in the form of a well-known package. The package includes a compiled program, a license information and a “dependency-data”. The “dependency-data” includes a dependency information showing a dependency between packages.

Specifically, the hard disk drive 17 stores repository set information in which the address of a device storing various packages is described, and, when a process based on the install utility is to be executed, the CPU 11 obtains a package to be installed from the device (area) storing various packages, on the basis of the address indicated by the repository set information, and then installs the package into the apparatus.

In the case where the URL of an external server apparatus 30 is described in the repository set information, for example, the CPU 11 accesses the external server apparatus 30 through the communication interface 19 on the basis of the URL, obtains the to-be-installed package stored in a hard disk drive 31 of the external server apparatus 30, from the external server apparatus 30 through the communication interface 19, and installs the package into the own apparatus.

In the case where the address of the driving device 25 is described in the repository set information, by contrast, the CPU obtains the to-be-installed package from the medium 27 through the driving device 25, and installs the package into the apparatus. In the repository set information, URLs of plural external server apparatuses 30 or the address of the driving device 25 can be described. Hereinafter, a device (area) storing various packages is referred to as “repository”.

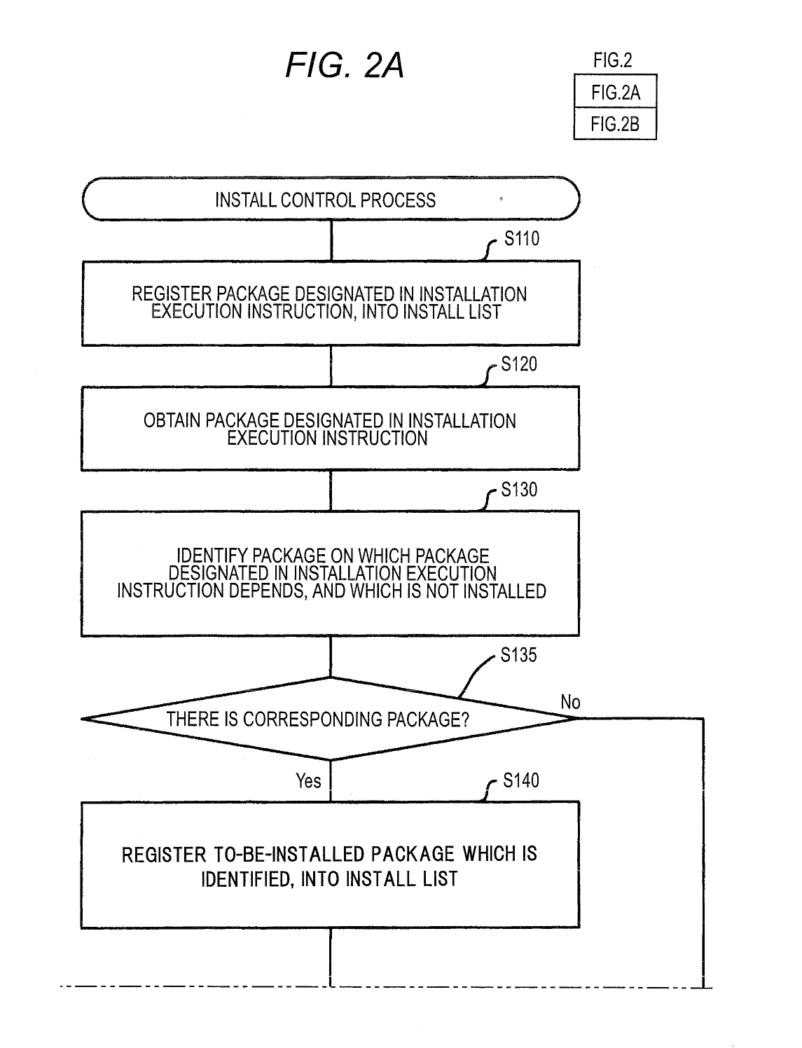

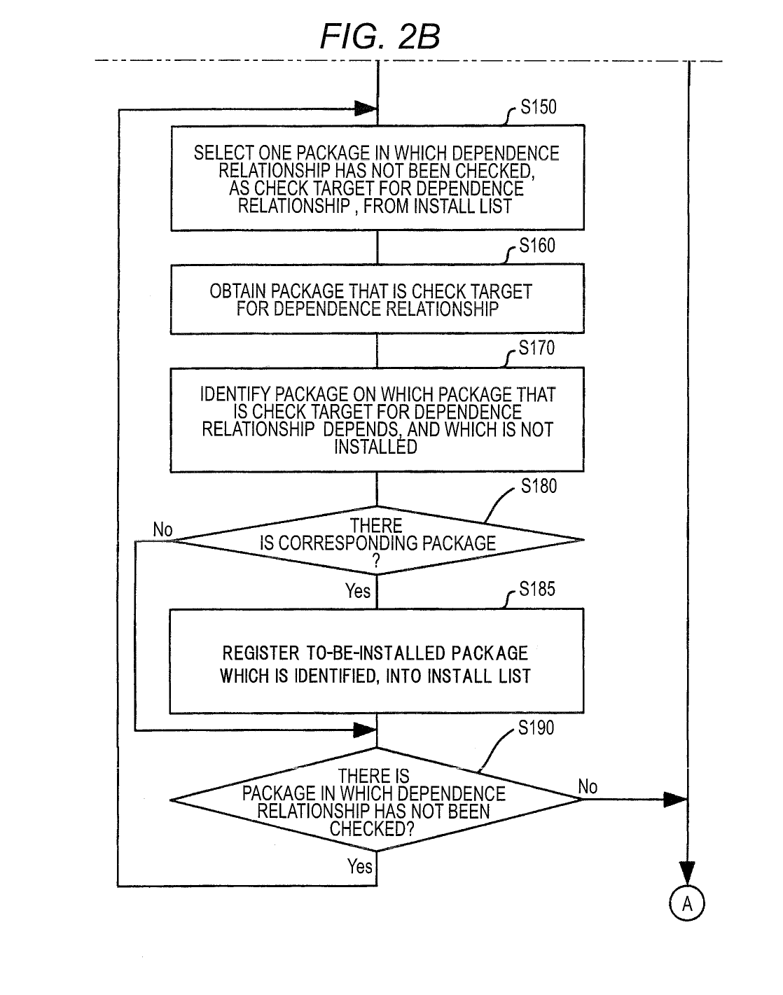

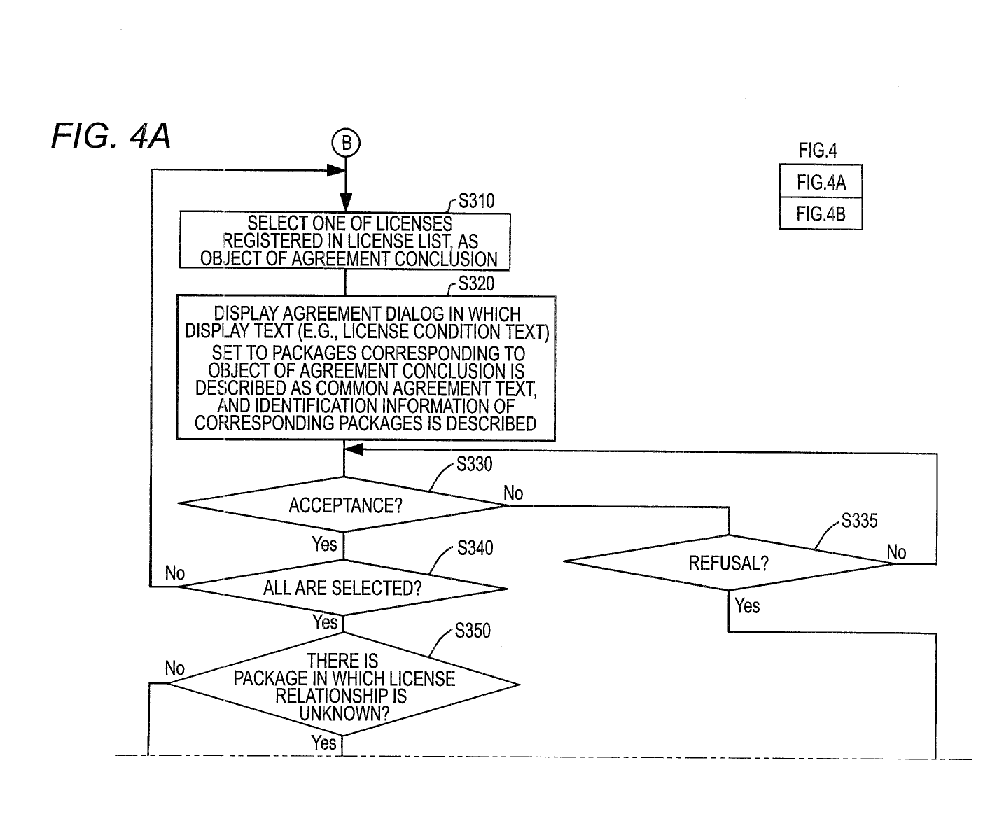

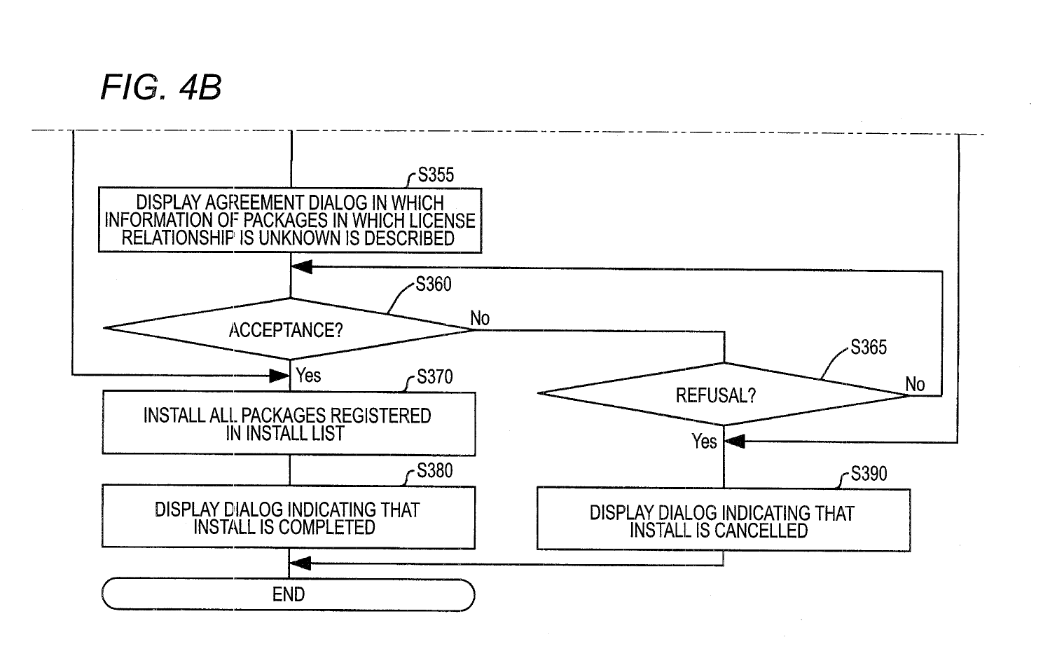

Then, the process which is executed by the CPU 11 based on the install utility stored in the hard disk drive 17 will be described in detail with reference to FIGS. 2 to 4. FIGS. 2 to 4 are flowcharts showing an install control process which, when an installation execution instruction is input by the user through the operating device 21, is executed by the CPU 11 on the basis of the install utility stored in the hard disk drive 17.

When the install control process is started, first, the CPU 11 registers the package which is designated in the installation execution instruction by the user, into an install list stored in the RAM 15 (S110). When the process is ended, the CPU obtains the package which is designated in the installation execution instruction, from the repository (such as the server apparatuses 30 or the medium 27) in accordance with the repository set information (S120).

Based on “dependency-data” stored in the obtained package, a package on which the package that is designated by the user in the installation execution instruction depends, and which is not installed in the apparatus is identified (S130).

In “dependency-data” stored in the package, the information of a package (or packages) which is in a dependence relationship with the package is described. In the case where there is package B which is in a dependence relationship with package A that is designated by the user in the installation execution instruction, the CPU 11 cannot normally execute a process corresponding to the package A unless both the package A and the package B are installed.

In S130, therefore, the CPU 11 specifies a package on which the package that is designated by the user in the installation execution instruction depends, on the basis of the data which are stored in the package, and which show the dependence relationship. The CPU specifies a package (or packages) to be installed, and registers the corresponding package (or packages) into the install list in the process described later.

In the case where, as a result of the process in S130, it is found that there is not a package to be installed, the CPU 11 makes a negative determination in S135, and the process of the CPU goes to S210 without performing the processes of S140 to S190. In the case where there is a package to be installed, the CPU 11 makes an affirmative determination in S135, and then to the process goes to S140.

When the process by the CPU goes to S140, the CPU 11 registers all of the packages to be installed, which are identified in the process of S130, into the install list.

Thereafter, the process by the CPU 11 goes to S150, and, from the install list, selects one package in which the dependence relationship has not been checked, as a check target for a dependence relationship. Here, the package in which the dependence relationship has not been checked means a package on which the process (the process of S130 or S170) of referring the data that are in a certain package, and that show the dependence relationship, and identifying a package to be installed that is in a dependence relationship with the certain package is not executed.

When one package which is a check target for the dependence relationship is selected in S150, the process of the CPU 11 goes to S160 to obtain the package to be installed that is a check target for the dependence relationship, from the repository, and, in a method similar to that of S130, then specifies a package on which the package that is a check target for the dependence relationship depends, and which is not installed in the apparatus (S170). In this case, the process is not applied to a package which has been already registered in the install list.

If there is a package to be installed (Yes in S180), all of the packages to be installed, which are identified in S170, are registered into the install list (S185), and then the process of the CPU goes to S190. By contrast, if there is no package to be installed (No in S180), the process of the CPU goes to S190 without performing the process of S185.

When to the process goes to S190, the CPU 11 determines whether or not a package in which the dependence relationship has not been checked exists in the packages registered in the install list. If it is determined that an unchecked package exists (Yes in S190), the process of the CPU goes to S150 to select one unchecked package as a check target for a dependence relationship, and executes the processes of S160 and the following. If it is determined that a package in which the dependence relationship has not been checked does not exist (No in S190), the process of the CPU goes to S210.

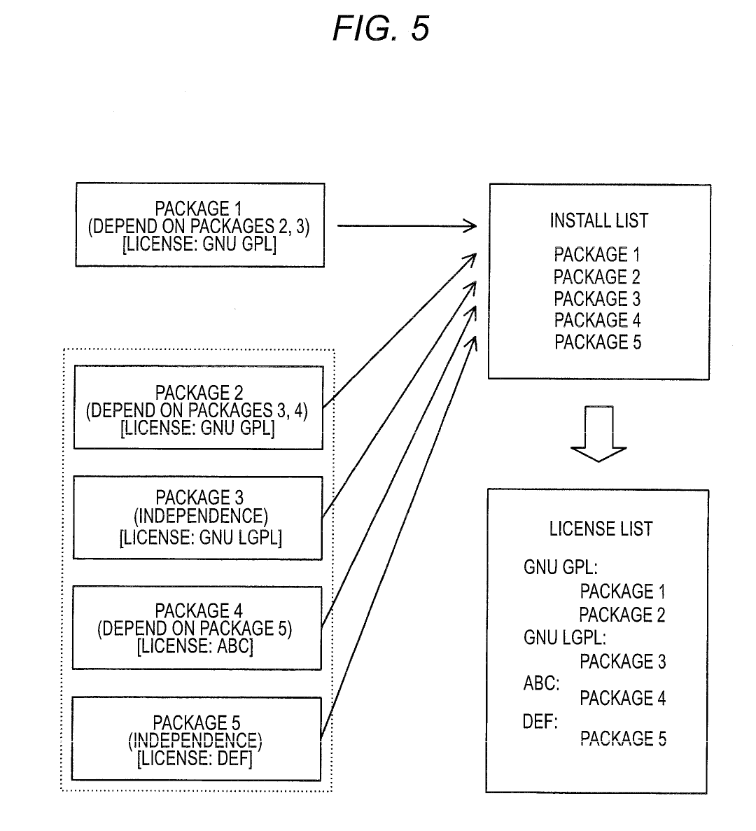

Namely, the CPU 11 executes the processes of S110 to S190 to, as shown in FIG. 5, register all of the packages to be installed, which are directly or indirectly in a dependence relationship with the package that is designated in the installation execution instruction, into the install list.

FIG. 5 is a view illustrating a specific example of the install list. In the example, together with Package 1 that is designated in the installation execution instruction, Packages 2 and 3 on which Package 1 depends, Packages 3 and 4 on which Package 2 depends, and Package 5 on which Package 4 depends are registered in the install list.

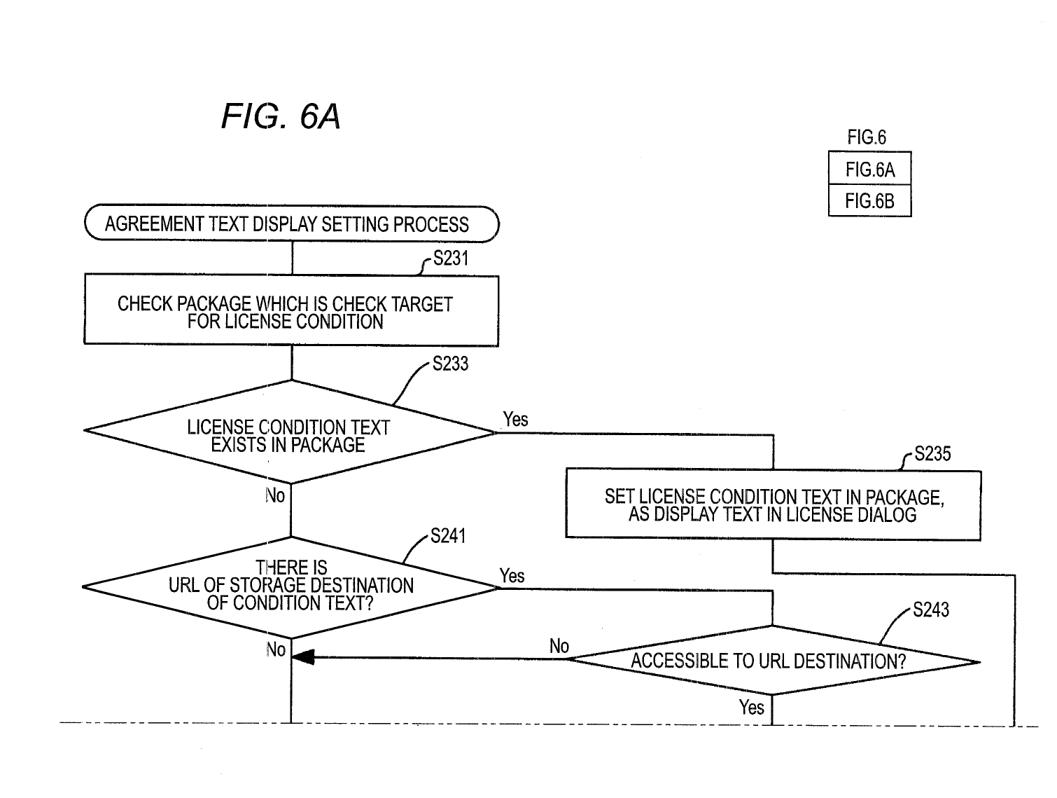

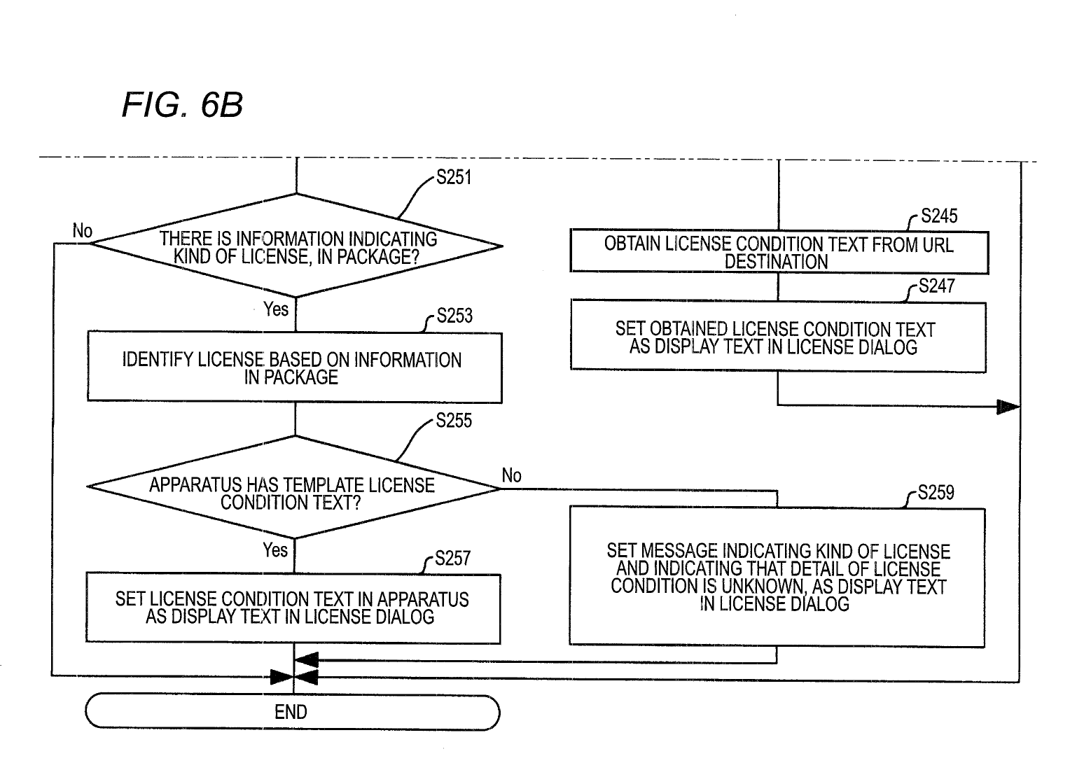

When the process goes to S210, the CPU 11 selects one of the packages registered in the install list, as an check target for the license condition, and then the process goes to S230 to execute an agreement text display setting process shown in FIG. 6. FIG. 6 is a flowchart showing the agreement text display setting process which is executed by the CPU 11.

When the agreement text display setting process is started, the CPU 11 checks in S231 the package which is an check target for the license condition, and determines whether text data in which terms (license condition) that must be concluded in the use of the package are described are stored as license information or not (S233).

If it is determined that such text data are stored (Yes in S233), the text data are read out from the package which is an check target for the license condition, and the license condition text indicated by the read out text data is set as a display text in a license dialog corresponding to the package which is an check target for the license condition (S235). Thereafter, the agreement text display setting process is ended.

As a result of the operation, the information processing apparatus 10 specifies the license which must be concluded when the package is to be used, and determines the agreement text which is to be displayed in the license dialog.

By contrast, if it is determined that such text data are not stored (No in S233), the process of the CPU 11 goes to S241, and determines whether link data which indicate the storage destination URL of the license condition text are stored or not as license information in the package which is an check target for the license condition. If the CPU determines that the link data are not stored (No in S241), the process of the CPU goes to S251, and, if the CPU determines that the link data are stored (Yes in S241), the process of the CPU goes to S243.

When the process goes to S243, the CPU 11 determines whether the storage destination URL can be accessed through the communication interface 19 or not. If the CPU determines that the access is impossible (No in S243), the process of the CPU goes to S251. By contrast, if the CPU determines that the access is possible (Yes in S243), the process of the CPU goes to S245 to obtain the text data in which the license condition that must be concluded in the use of the package are described, from the storage destination URL through the communication interface 19.

Then, the license condition text indicated by the text data which are obtained through the communication interface 19 is set as the display text in the license dialog corresponding to the package which is an check target for the license condition (S247). Thereafter, the agreement text display setting process is ended.

Additionally, if the CPU determines that also the link data are not stored (No in S241), the CPU 11 determines whether data indicating the kind of the license which is to be concluded are stored in the package or not (S251). If the CPU determines that data indicating the kind of the license are not stored (No in S251), the agreement text display setting process is ended.

By contrast, if the CPU determines that data indicating the kind of the license are stored (Yes in S251), the CPU specifies the license which must be concluded in the use of the package, on the basis of the data indicating the kind of the license (S253).

In the case where data indicating that the agreement is “GNU GPL (General Public License)” are stored in the package, for example, the CPU determines that the license which must be concluded is “GNU GPL”. Then, the process of the CPU goes to S255.

When the process goes to S255, the CPU 11 determines whether or not text data in which the license condition for the identified license are previously stored in the hard disk drive 17 together with the install utility. If the CPU determines that such text data are stored (Yes in S255), the CPU reads out the corresponding text data from the hard disk drive 17, and sets the license condition text indicated by the read out text data, as a display text in a license dialog corresponding to the package which is an check target for the license condition (S257). Thereafter, the agreement text display setting process is ended.

Many of pieces of application software of Linux (registered trademark) are distributed under GPL or LGPL. In the embodiment, therefore, license condition texts of, for example, GPL and LGPL are previously stored as text data together with the install utility in the hard disk drive 17, thereby allowing the data to be read out and used in S257.

By contrast, if the CPU determines that the text data corresponding to the identified license are not stored (No in S255), the process of the CPU 11 goes to S259 to set a message in which the kind of the identified license is indicated, and which describes that the detail of the license condition is unknown, as the display text in the license dialog corresponding to the package which is an check target for the license condition. Thereafter, the agreement text display setting process is ended.

When the agreement text display setting process is ended in this way, the CPU 11 determines whether or not all of the to-be-installed packages registered in the install list are selected as an check target for the license condition (S270). If the CPU determines that all of the packages are not selected (No in S270), the process of the CPU goes to S210 to newly select one of the unselected packages as an check target for the license condition, and then executes the processes of S230 and the following.

By contrast, if the CPU determines that all of the packages are selected as an check target for the license condition (Yes in S270), the process of the CPU 11 goes to S290, and divides the to-be-installed packages registered in the install list into groups each configured by packages having the same license which is to be concluded, thereby producing a license list in which correspondence relationships between the licenses (licenses) and the packages are listed.

Specifically, in S290, one group of packages in which the display texts set in the agreement text display setting process are coincident with one another is detected as a package group of the same license which is to be concluded. For each package group of the same license which is to be concluded, then, a license list in which identification information of packages belonging to the package group is listed while correlated with license identification information which is identification information of the license is produced (see FIG. 5).

With respect to packages in which the display texts are not coincident with one another, the license list is produced for each of the packages while the identification information of the package is described with correlated with the license identification information of the license corresponding to the package. In the license list, however, the identification information of a package in which a display text is not set in the agreement text display setting process, and in which the license relationship is unknown is not registered into the license list.

Examples of the package identification information which is described in the license list are the package name, and the file name of the package. As other license identification information, information (for example, character strings of “GNU GPL” and “GNU LGPL”) indicating the kind of the corresponding license may be used. The kind of the license can be identified from, for example, the license condition text.

When the process of S290 is ended in this way, the process of the CPU 11 goes to S310 to select one of the license identification information registered in the license list. Therefore, the CPU 11 selects the license corresponding to the selected license identification information, as the license which is an object of agreement conclusion.

When the process of S310 is ended, the process of the CPU 11 goes to S320 to display the license dialog on the displaying device 23. The license dialog is a dialog in which identification information of packages that are correlated with the selected license identification information in the license list is described, and the display text that is set in common to the packages in the agreement text display setting process is described as an agreement text which is common to the packages. In the embodiment, an agreement text for packages distributed under common license agreement is displayed once.

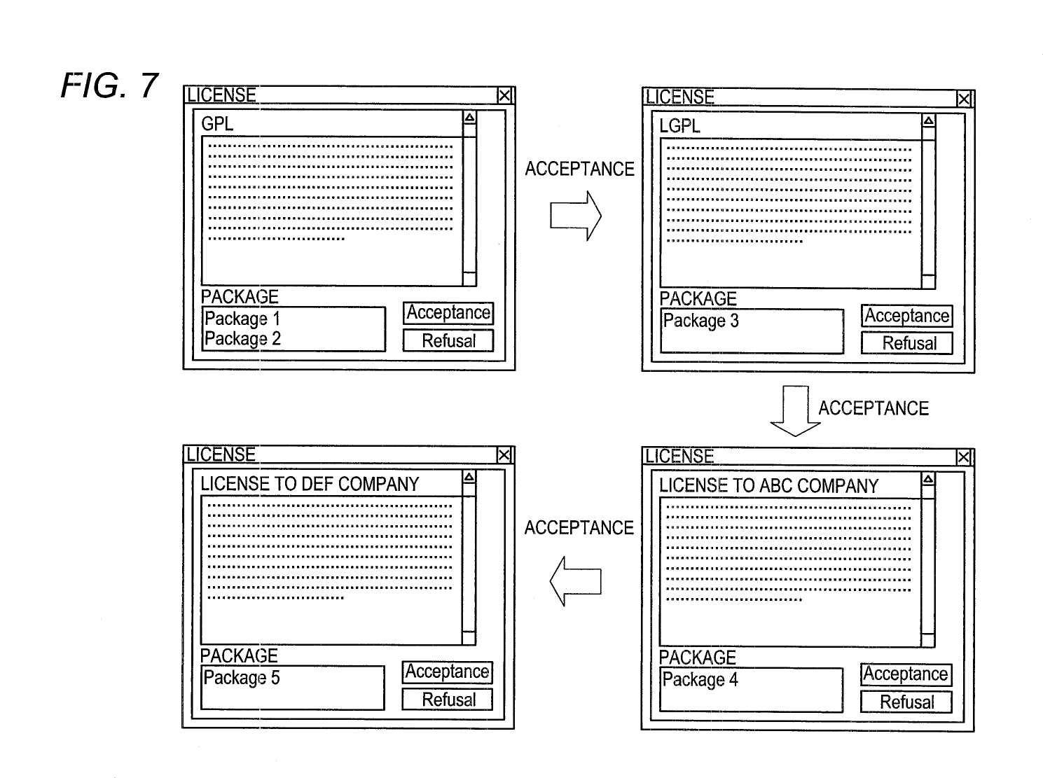

FIG. 7 is a view showing the configuration of the license dialog. The license dialog shown in FIG. 7 is an example in the case where the license list has the configuration shown in FIG. 5. In the license list shown in FIG. 5, the license identification information “GNU GPL” is correlated with Package 1 and Package 2.

In this case, when the license identification information “GNU GPL” is selected in S310, a text corresponding to “GNU GPL” and name of packages distributed under “GNU GPL” (for example, “Package 1” and “Package 2”) are displayed in the license dialog.

When the process of S320 is ended, the CPU 11 waits until the intention of agreement conclusion or that of refusal is input by the user by, through the operating device 21, clicking one of “Acceptance” button which is an input object that is disposed in the license dialog, and that is used for inputting the intention of agreement conclusion, and “Refusal” button which is an input object that is used for inputting the intention of refusal of agreement conclusion (S330, S335).

When “Acceptance” button is clicked (Yes in S330), the license dialog which is displayed on the displaying device 23 is closed, and then the following decision is made. Namely, it is determined whether all of the licenses registered in the license list are selected as items subjected to agreement conclusion or not (S340).

In the case where there is an unselected license, the CPU 11 makes a negative determination (No in S340), and the process of the CPU goes to S310 to select the license which is not selected as an item subjected to agreement conclusion, as a new item subjected to agreement conclusion, and then executes the processes of S320 and the following.

By contrast, in the case where all of the licenses registered in the license list are selected as item subjected to agreement conclusion, the CPU makes an affirmative determination in S340, and then the process goes to S350.

When the process of the CPU goes to S350, the CPU 11 determines whether a package in which the license relationship is unknown, i.e., a package which is registered in the install list, and which is not registered in the license list exists or not. If the CPU determines that there is a package in which the license relationship is unknown (Yes in S350), the process of the CPU goes to S355. By contrast, if the CPU determines that there is not a package in which the license relationship is unknown (No in S350), the process of the CPU goes to S370.

In S355, among packages which are registered in the install list, a group of packages which are not registered in the license list is handled as a package group in which the license relationship is unknown, and a license dialog in which the identification information of these packages in which the license is unknown is described, and a message indicating that the kind of the license corresponding to the packages is unknown is described is displayed on the displaying device 23.

Thereafter, the CPU 11 waits until the intention of agreement conclusion or that of refusal is input by the user by, through the operating device 21, clicking one of “Acceptance” button which is an input object that is disposed in the license dialog, and that is used for inputting the intention of agreement conclusion, and “Refusal” button which is an input object that is similarly disposed in the license dialog, and that is used for inputting the intention of refusal of agreement conclusion (S360, S365).

When “Acceptance” button is clicked (Yes in S360), the license dialog which is displayed on the displaying device 23 is closed, and then all of the packages which are registered in the install list are installed into the apparatus in accordance with the dependence relationship (S370).

After the install is completed, a dialog indicating that the install is completed is displayed on the displaying device 23 (S380), and, when “OK” button in the dialog is clicked, the install control process is ended.

As described above, in the install control process in the embodiment, for each of the kinds of licenses, the license dialog in which the agreement text of the license is described is displayed on the displaying device 23 (see FIG. 7), and, at a timing when the intention of agreement conclusion is input for all of the licenses, the install of the packages which are registered in the install list is started.

By contrast, when “Refusal” button in the license dialog is clicked (Yes in S335 or Yes in S365), the process of the CPU 11 goes to S390, closes the license dialog which is displayed on the displaying device 23, and then displays a dialog indicating that the install is cancelled, on the displaying device 23. When “OK” button in the dialog is clicked, the install control process is ended.

According to the information processing apparatus 10 as described above, when a plurality of packages distributed under the same license are installed at once, the agreement text of the license for the same license is displayed once.

According to the information processing apparatus 10, in the case where packages having the same license exist in a group of packages which are registered in the install list, and which are to be installed, therefore, the number of agreement texts which are to be checked by the user can be decreased, and the burden on the user in the case where a plurality of packages are to be installed can be reduced.

According to the embodiment, with respect to packages in which packages having the same license do not exist, the input object through which the intention of concluding the license of each of the packages can be input is displayed for each of the packages on the displaying device 23, but, with respect to packages in which packages having the same license exist, the input object through which the intention of concluding the licenses of the packages can be input is displayed for each group of packages having the same license on the displaying device 23.

According to the embodiment, in the case where packages having the same license exist in a group of packages which are to be installed, therefore, operations of inputting the intention of concluding the license through the input object can be decreased. Namely, it is not required to perform a plurality of operations of inputting the intention of agreement conclusion, on the same package group of the same license. According to the embodiment, therefore, the burden on the user with respect to the operation of inputting the intention of agreement conclusion can be reduced.

According to the embodiment, at a timing when the intention of concluding the license is input for all of the packages, the install of the packages is started. Even in the case where the user refuses the license in mid-course, therefore, the installing work is not wastefully performed.

In the embodiment, the license condition text is displayed. The license conditions of “GNU GPL”, “GNU LGPL”, and the like are well known, and hence only the kinds of licenses (“GNU GPL” and the like) may be displayed. Although in the embodiment, the agreement text is employed as agreement information, the present invention is not limited thereto. For example, an agreement image, an agreement icon, etc. may be employed as the agreement information.

### Second Embodiment

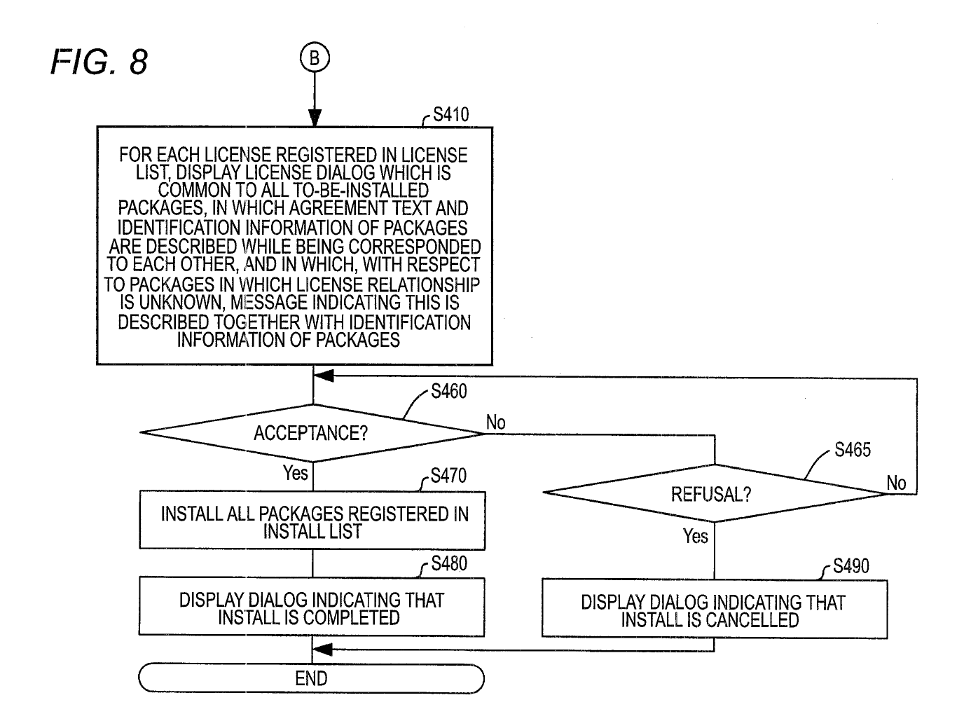

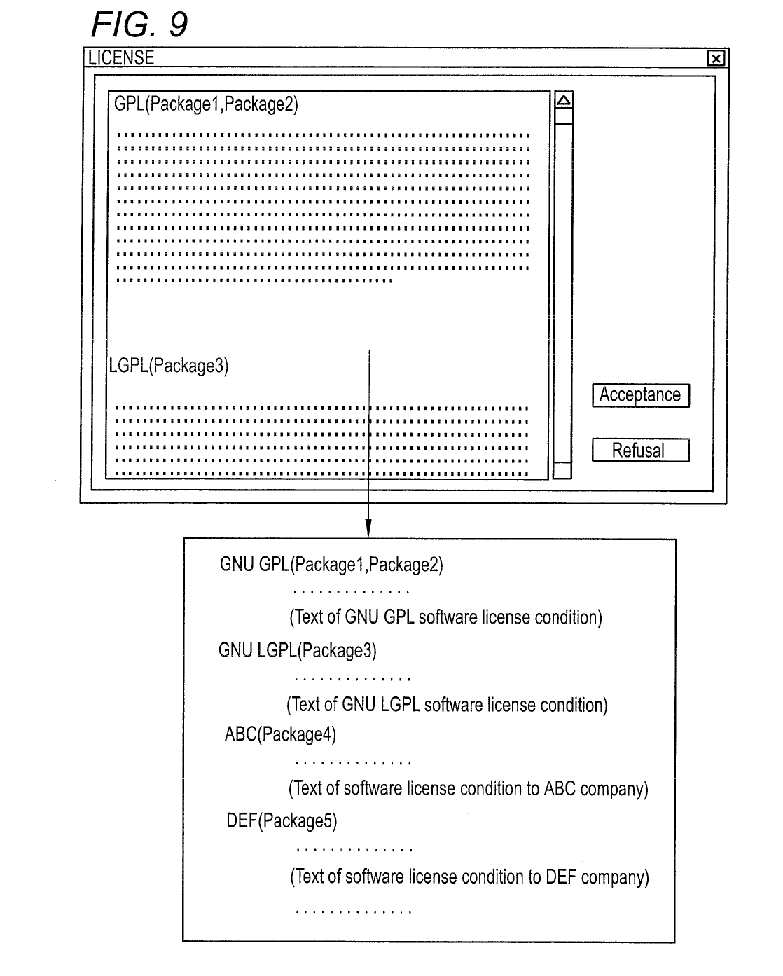

Then, an information processing apparatus 10 of a second embodiment will be described. The hardware configuration of the information processing apparatus 10 of the second embodiment is identical with that of the first embodiment. The information processing apparatus 10 is different from the first embodiment, approximately only in a part of the contents of the install control process to be executed. Hereinafter, as the description of the information processing apparatus 10 of the second embodiment, therefore, the configuration which is different from the first embodiment is selectively described with reference to FIGS. 8 and 9.

FIG. 8 is a flowchart showing a part of an install control process which is executed by the CPU 11, in the second embodiment.

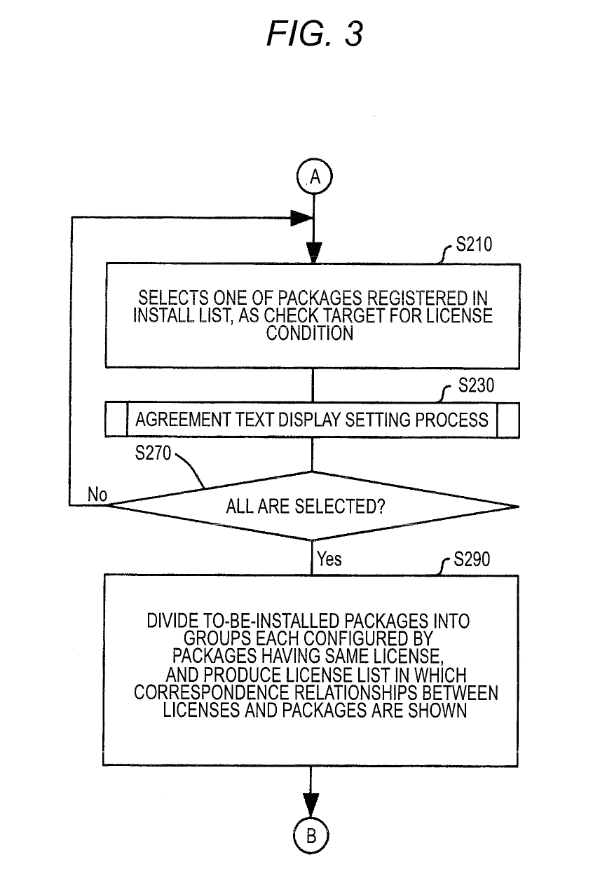

In the second embodiment, similarly with the first embodiment, when the install control process is started, the CPU 11 executes the processes of S110 to S290 (see FIGS. 2 and 3). When the license list is produced in S290, the process of the CPU 11 goes to S410.

When the process goes to S410, the CPU 11 displays on the displaying device 23 a license dialog which is common to all of the to-be-installed packages registered in the install list, and, with respect to packages having the same license, the agreement text which is common to the packages is described, on the basis of the license list produced in S290 and the install list (see FIG. 9).

Specifically, with respect to packages registered in the license list, for each license (in other words, for each license identification information), the license dialog in which a common display text that is set for packages corresponding to the license, and identification information of the packages are described while being corresponded to each other is displayed on the displaying device 23 (see FIG. 9).

By contrast, with respect to packages which are registered in the install list, which are not registered in the license list, and in which the license relationship is unknown, identification information of the packages is displayed while being corresponded to a message indicating that the kind of the license corresponding to the packages is unknown.

In S410, namely, when agreement texts of to-be-installed packages are to be displayed in a single license dialog, an agreement text is not described for each of the packages in the license dialog, but an agreement text is described for each of licenses. In the embodiment, as described above, with respect to a group of packages having the identical license to be concluded, the common agreement text is displayed in the license dialog, so that the identical agreement text is prevented from being redundantly displayed.

With respect to packages in which packages having the same license do not exist, for each of the packages, a display text which is set for the package is described as the agreement text of the license, together with the identification information of the package in the license dialog.

In the license dialog which is displayed in S410, an input object through which the intention of concluding the agreement can be input is not disposed for each of the licenses, but a single input object through which the intention of concluding all of the licenses can be collectively input is disposed, so that the user's operation of the input object is simplified.

FIG. 9 is a view showing the configuration of the license dialog which is displayed on the displaying device 23 by the process of S410 in the embodiment. In FIG. 9, the upper half is a view showing a display example of the license dialog, and the lower half is a view showing the contents of all of the license texts which can be displayed in the license dialog. When the user operates a scroll bar of the license dialog, the user can check the contents of all of the license texts. As shown in FIG. 9, “Acceptance” button that is an input object through which the intention of concluding all of the licenses can be collectively input, and “Refusal” button that is an input object through which the intention of refusing conclusion of the licenses can be collectively input are disposed in the license dialog.

After the process of S410, the CPU 11 waits until the intention of agreement conclusion or that of refusal is input by the user through the license dialog, by clicking one of “Acceptance” button and “Refusal” button (S460, S465).

When “Acceptance” button is clicked (Yes in S460), the license dialog which is displayed on the displaying device 23 is closed, and then all of the packages which are registered in the install list are installed into the apparatus in accordance with the dependence relationship (S470).

After the install is completed, a dialog indicating that the install is completed is displayed on the displaying device 23 (S480), and, when “OK” button in the dialog is clicked, the install control process is ended.

By contrast, when “Refusal” button in the license dialog is clicked (Yes in S465), the CPU 11 executes a process similar to that of S390, in S490, and then the install control process is ended.

The information processing apparatus 10 of the embodiment has been described. According to the information processing apparatus 10, the input object through which the intention of collectively concluding the licenses of to-be-installed packages can be input is displayed in the license dialog. Therefore, the user is not required to individually perform the operation of inputting the intention of concluding the license through the input object, for each of packages or licenses. According to the embodiment, namely, the burden with respect to the operation of an input object in the install can be largely reduced.

According to the embodiment, in the license dialog, the identical agreement text is prevented from being redundantly displayed, and hence the burden on the user with respect to the work of checking the agreement text can be reduced.

According to the embodiment, as described above, the identical agreement text is prevented from being redundantly displayed. Alternatively, a redundant display may be allowed in the license dialog, and the agreement text may be displayed for each package. Even in the configuration, when the above-described input object is disposed in the license dialog, at least the burden with respect to the operation of an input object in the install can be reduced.

In the embodiment, the license condition text is displayed. The license conditions of “GNU GPL”, “GNU LGPL”, and the like are well known, and hence only the kinds of licenses (“GNU GPL” and the like) may be displayed.

### Third Embodiment

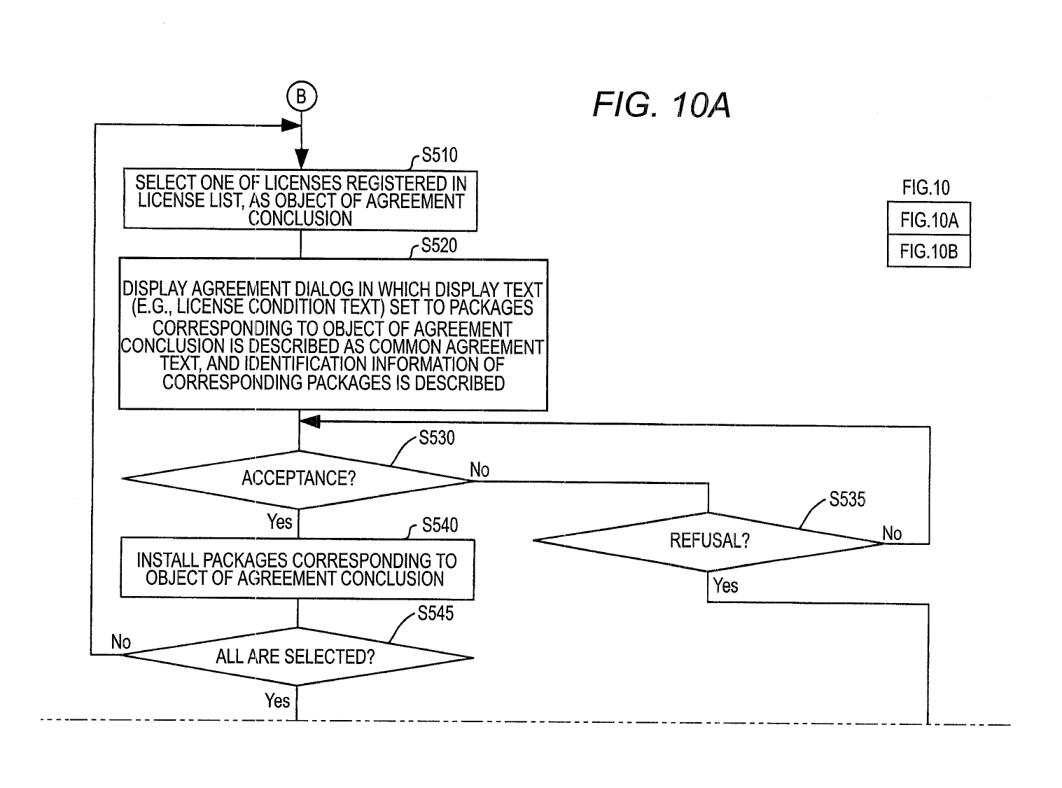

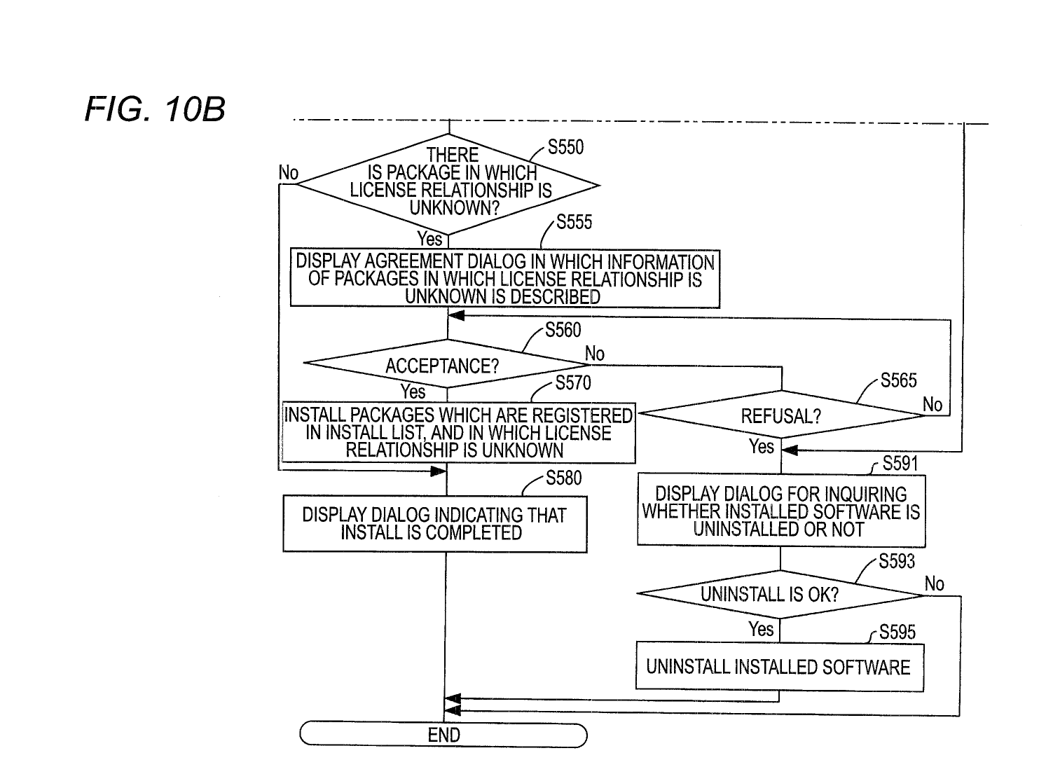

Then, an information processing apparatus 10 of a third embodiment will be described. The hardware configuration of the information processing apparatus 10 of the third embodiment is identical with that of the first embodiment. The information processing apparatus 10 is different from the first embodiment, approximately only in a part of the contents of the install control process to be executed. Hereinafter, as the description of the information processing apparatus 10 of the third embodiment, therefore, the configuration which is different from the first embodiment is selectively described with reference to FIG. 10.

FIG. 10 is a flowchart showing a part of an install control process which is executed by the CPU 11, in the third embodiment.

In the third embodiment, similarly with the first embodiment, when the install control process is started, the CPU 11 executes the processes of S110 to S290 (see FIGS. 2 and 3). When the license list is produced in S290, the process of the CPU 11 goes to S510.

When the process goes to S510, the CPU 11 executes processes similar to those of S310, S320, S330, and S335 in the first embodiment, in S510, S520, S530, and S535, whereby one of the licenses registered in the license list is selected as an item subjected to agreement conclusion, and the license dialog for concluding the license of the item subjected to agreement conclusion is displayed on the displaying device 23.

When “Acceptance” button in the license dialog is clicked (Yes in S530), the process of the CPU goes to S540 to close the license dialog which is displayed on the displaying device 23, and install packages which correspond to the license of the item subjected to agreement conclusion, into the apparatus. Thereafter, the process of the CPU goes to S545.

When the process goes to S545, the CPU 11 determines whether or not all of the licenses registered in the license list are selected as an item subjected to agreement conclusion. If the CPU makes a negative determination (No in S545), the process of the CPU goes to S510 to select a license which has not been selected as an item subjected to agreement conclusion, as a new item subjected to agreement conclusion, and then executes the processes of S520 and the following. If the CPU makes an affirmative determination (Yes in S545), the process of the CPU goes to S550.

When the process goes to S550, the CPU 11 executes processes similar to those of S350, S355, S360, and S365 in the first embodiment, in S550, S555, S560, and S565.

Namely, in the case where there is a package in which the license relationship is unknown, a license dialog for the package in which the license relationship is unknown is displayed (S555), and the CPU waits until “Acceptance” button or “Refusal” button in the license dialog is clicked (S560, S565). If “Acceptance” button is clicked (Yes in S560), the license dialog which is displayed on the displaying device 23 is closed, and then all of packages in which the license relationship is unknown are installed into the apparatus (S570).

After the install is completed, a dialog indicating that the install is completed is displayed on the displaying device 23 (S580), and, when “OK” button in the dialog is clicked, the install control process is ended.

In the case where there is no package in which the license relationship is unknown (No in S550), the process of the CPU goes to S580 without displaying the license dialog in S555, and performs the above-described processes. Thereafter, the install control process is ended.

Furthermore, when “Refusal” button in the license dialog which is displayed in S520 or S555 is clicked (Yes in S535 or Yes in S565), the process of the CPU 11 goes to S591, the license dialog which is displayed on the displaying device 23 is closed, and then the following dialog is displayed on the displaying device 23.

Namely, a dialog for inquiring whether the package which is installed into the apparatus by the process of S540 in the present install control process is to be uninstalled or not is displayed on the displaying device 23 (S591).

If the user inputs the intention of uninstalling by operating an input object disposed in the dialog (Yes in S593), the package which is installed into the apparatus by the process of S540 in the present install control process is uninstalled (S595), and then the install control process is ended.

By contrast, if the user inputs the intention not to uninstall (No in S593), the install control process is ended without performing the process of S595.

The information processing apparatus 10 of the third embodiment has been described. According to the embodiment, each time when “Acceptance” button is clicked in the license dialog, a package corresponding to the license is installed, and, when “Refusal” button is clicked in the license dialog, a package which has been installed is uninstalled.

According to the embodiment, therefore, a package which is made unnecessary by refusal of the license by the user can be prevented from remaining installed. Therefore, it is possible to prevent the free space of the hard disk drive 17 from being reduced by unnecessary packages remaining in the hard disk drive 17.

By contrast, in the case where, even when “Refusal” button is clicked in the license dialog, the user inputs the intention not to uninstall, a package which has been installed is remained to be stored, and hence a package which has been installed can be intentionally remained.

According to the embodiment, each time when “Acceptance” button is clicked in the license dialog, a package corresponding to the license is installed. Insofar as “Refusal” button is not clicked, therefore, the whole installing work can be ended more rapidly than the case many packages are installed as in the first embodiment.

### Fourth Embodiment

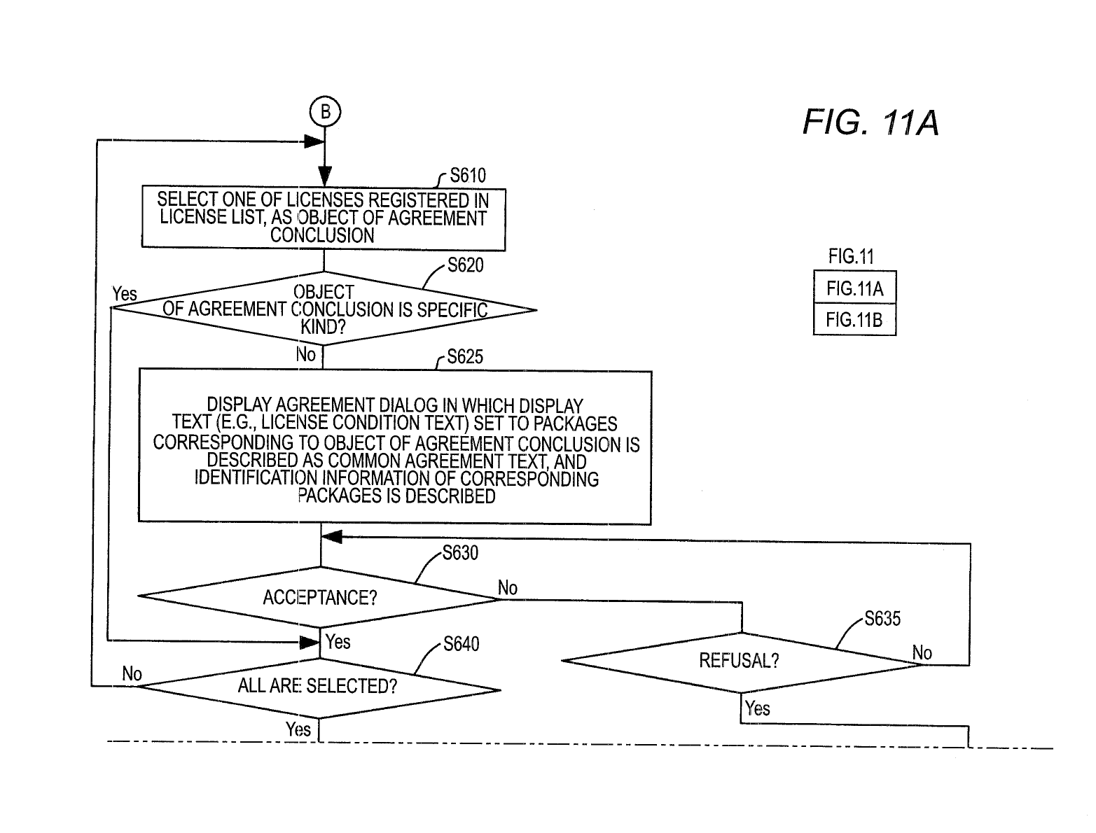

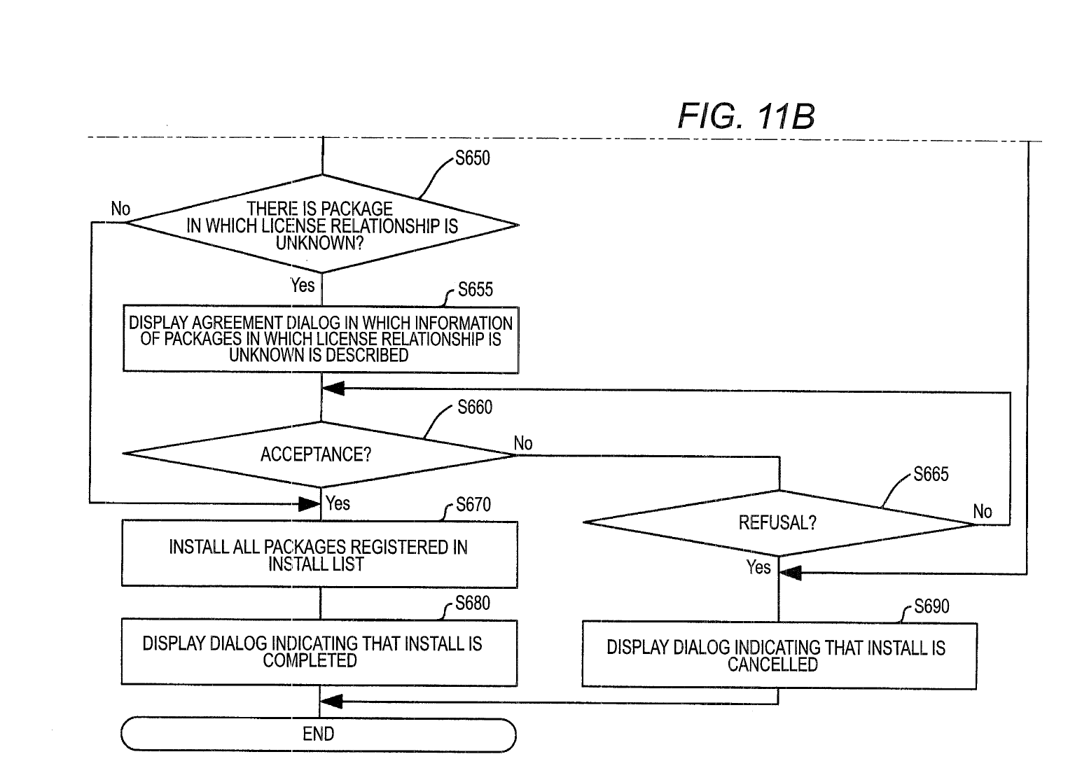

Then, an information processing apparatus 10 of a fourth embodiment will be described. The hardware configuration of the information processing apparatus 10 of the fourth embodiment is identical with that of the first embodiment. The information processing apparatus 10 is different from the first embodiment, approximately only in a part of the contents of the install control process to be executed. Hereinafter, as the description of the information processing apparatus 10 of the fourth embodiment, therefore, the configuration which is different from the first embodiment is selectively described with reference to FIG. 11.

FIG. 11 is a flowchart showing a part of an install control process which is executed by the CPU 11, in the fourth embodiment.

In the fourth embodiment, similarly with the first embodiment, when the install control process is started, the CPU 11 executes the processes of S110 to S290 (see FIGS. 2 and 3). When the license list is produced in S290, the process of the CPU goes to S610.

When the process goes to S610, the CPU 11 executes a process similar to that of S310 to select one of licenses registered in the license list, as an item subjected to agreement conclusion, and then the process goes to S620.

When the process goes to S620, the CPU determines whether the license subjected to agreement conclusion is a license of a specific kind or not. Specifically, the CPU determines whether or not the license subjected to agreement conclusion is “GNU GPL” or “GNU LGPL” which is a license of the specific kind.

If the CPU determines that the license subjected to agreement conclusion is a license of the specific kind (Yes in S620), it is deemed that the user has the intention of concluding the license, and the process of the CPU goes to S640 without displaying the license dialog for the license.

By contrast, if the CPU determines that the license subjected to agreement conclusion is not a license of the specific kind (No in S620), the process of the CPU 11 goes to S625 to, similarly with the process of S320, display the license dialog corresponding to the license subjected to agreement conclusion, on the displaying device 23, and waits until “Acceptance” button or “Refusal” button in the license dialog is clicked (S630, S635). When “Acceptance” button is clicked, the process of the CPU goes to S640, and, when “Refusal” button is clicked, the process of the CPU goes to S690.

When the process goes to S690, similarly with process of S340, the CPU 11 determines whether all of the licenses registered in the license list are selected as an item subjected to agreement conclusion or not. If the CPU makes a negative determination (No in S640), the process of the CPU goes to S610, and, if the CPU makes an affirmative determination (Yes in S640), the process of the CPU goes to S650. The subsequent processes are executed in a similar manner as the first embodiment. In S650, S655, S660, S665, S670, S680, and S690, namely, processes which are similar to those of S350, S355, S360, S365, S370, S380, and S390 are executed. Thereafter, the install control process is ended.

The information processing apparatus 10 of the fourth embodiment has been described. According to the information processing apparatus 10, a license dialog for a package in which the license that must be concluded is a license of a specific kind is not displayed on the displaying device 23, and only a license dialog for a package which does not include a license of a specific kind is displayed on the displaying device 23. Therefore, the burden of the installing work on the user can be further reduced.

Namely, the license conditions of “GNU GPL” and “GNU LGPL” are loose conditions which are not violated in a usual package use. With respect to a license of such a kind, therefore, the possibility that a problem occurs is low even when the intention of the user is not considered. In a configuration where, as in the embodiment, an operation of inputting the intention of agreement conclusion through a license dialog is not requested, therefore, the burden on the user with respect to the operation of an input object in the install can be further reduced.

### Fifth Embodiment

Then, an information processing apparatus 10 of a fifth embodiment will be described. The hardware configuration of the information processing apparatus 10 of the fifth embodiment is identical with that of the first embodiment. The information processing apparatus 10 is different from the first embodiment, approximately only in a part of the contents of the install control process to be executed. Hereinafter, as the description of the information processing apparatus 10 of the fifth embodiment, therefore, the configuration which is different from the first embodiment is selectively described.

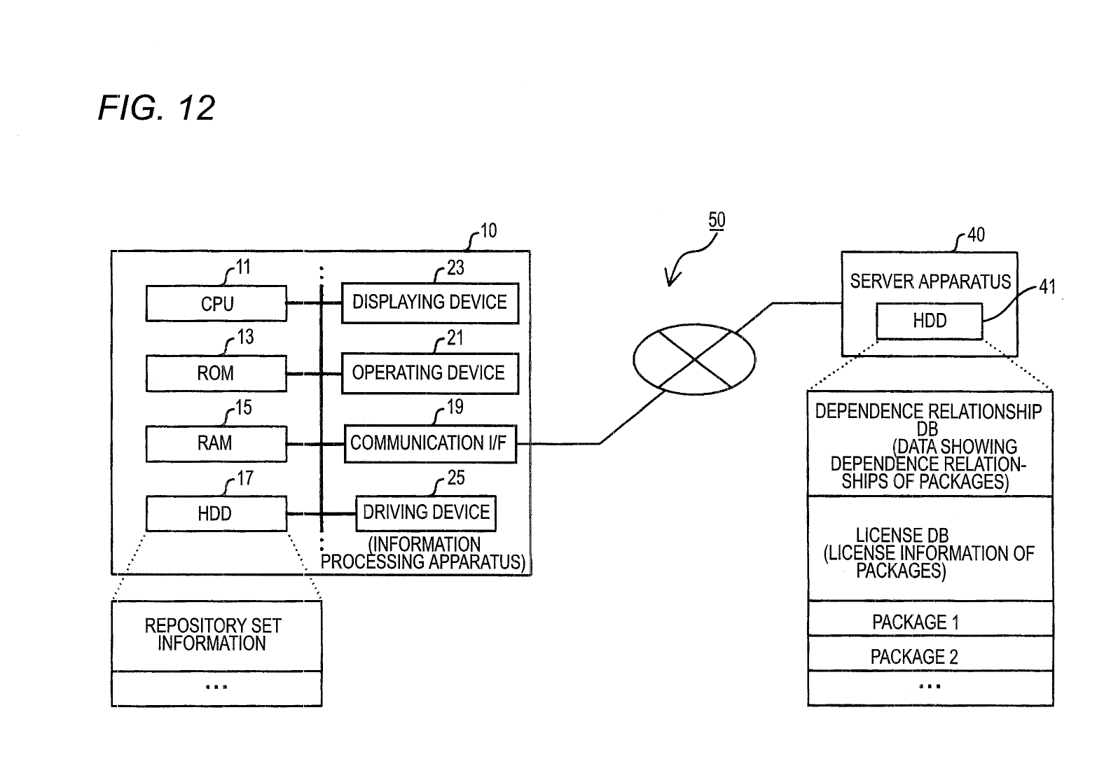

In the fifth embodiment, the following precondition is set. Namely, it is assumed that the information processing apparatus 10 of the fifth embodiment is communicatably connected through a network to a server apparatus 40 having the configuration shown in FIG. 12.

FIG. 12 is a block diagram showing the configuration of a communication system 50 to which the information processing apparatus 10 of the fifth embodiment is connected. In the embodiment, as shown in FIG. 12, the server apparatus 40 which functions as a repository includes, in a hard disk drive 41, various packages, a dependence relationship DB (database), and a license DB.

The dependence relationship DB of the server apparatus 40 is a database which, for each of packages that can be provided by the server apparatus 40, has data indicating the dependence relationship of the package. The data indicating the dependence relationship are equivalent to data included in a package. The communication system 50 in the embodiment is configured so that, even when the information processing apparatus 10 does not refer the contents of a package while downloading the package from the server apparatus 40, the dependence relationship of a desired package can be checked by, for example, downloading data indicating the dependence relationship from the server apparatus 40.

The license DB of the server apparatus 40 is a database which, for each of packages that can be provided by the server apparatus 40, has text data describing license conditions of the package, as license information. Namely, the communication system 50 in the embodiment is configured so that, even when the information processing apparatus 10 does not refer the contents of a package while downloading the package from the server apparatus 40, the license condition of a desired package can be checked by, for example, downloading the text data from the server apparatus 40.

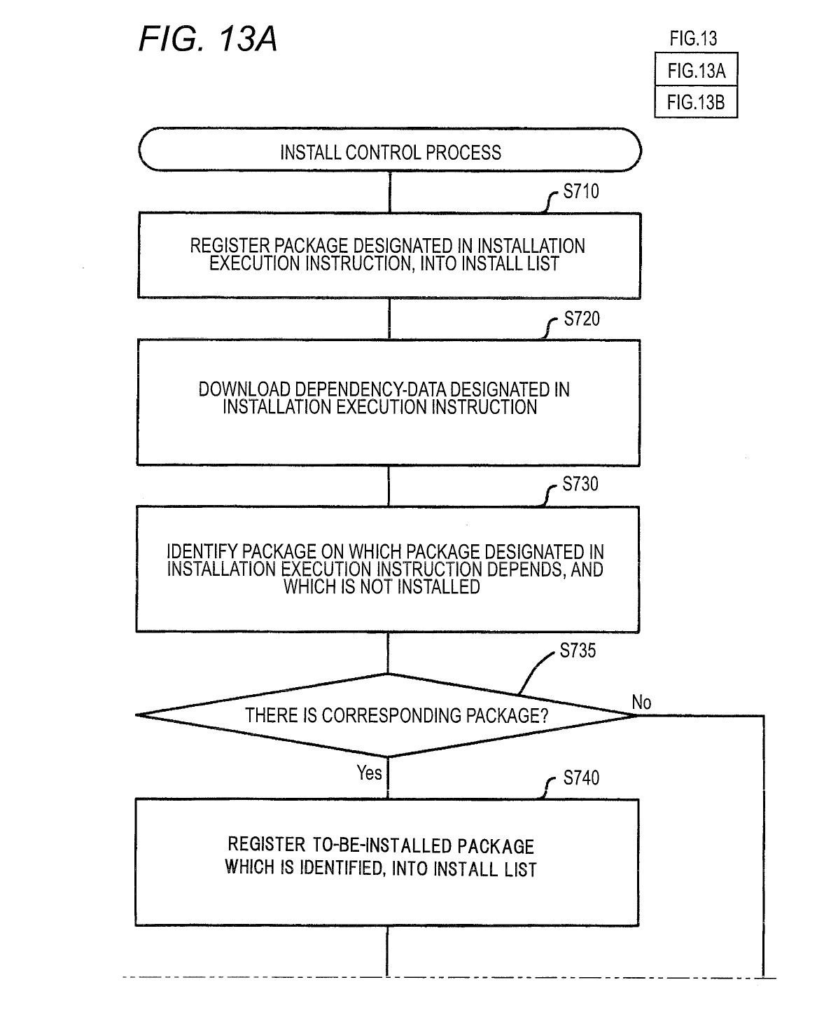

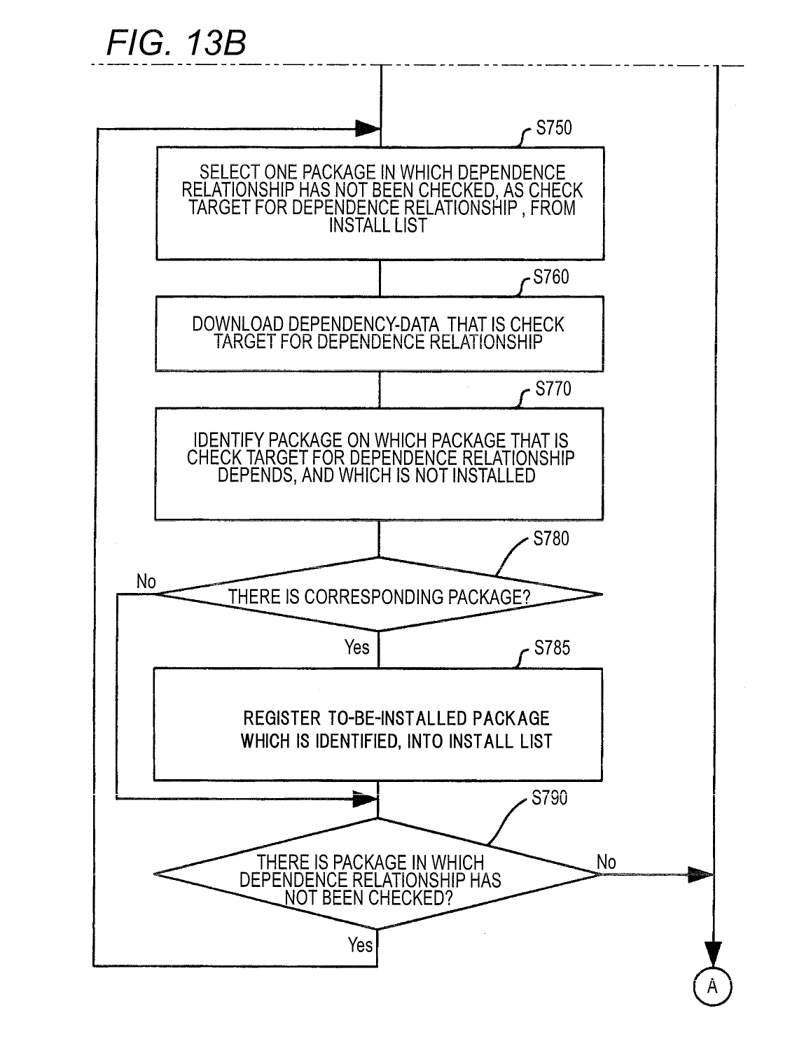

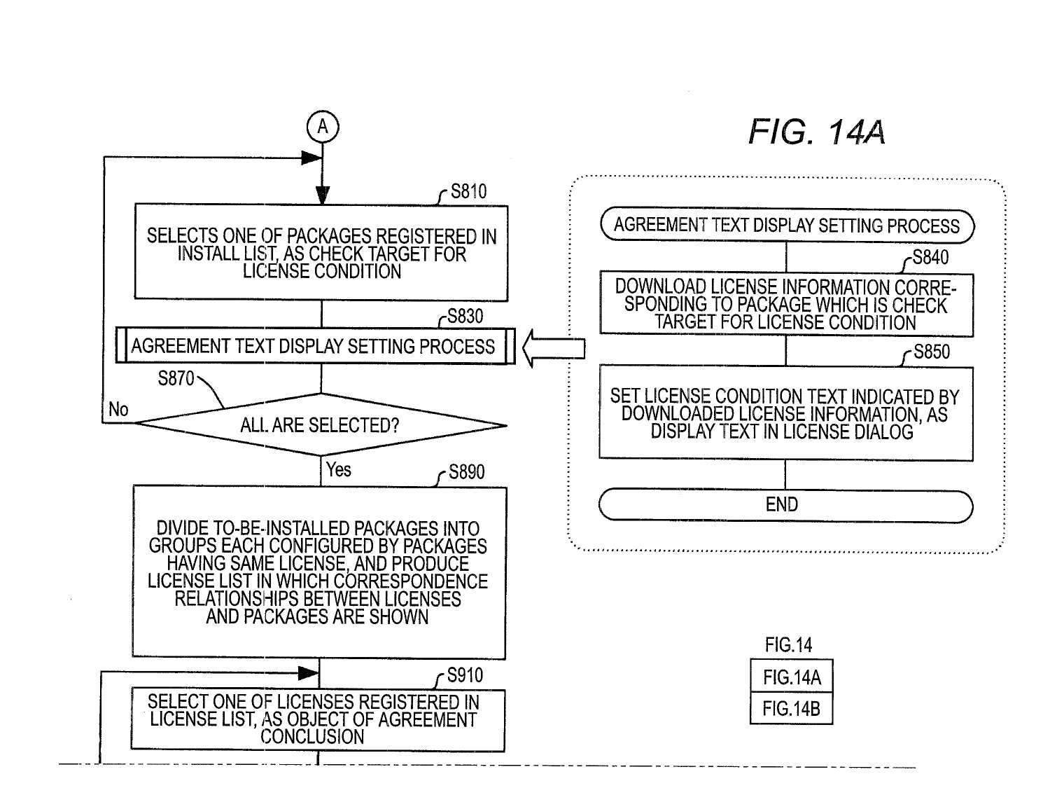

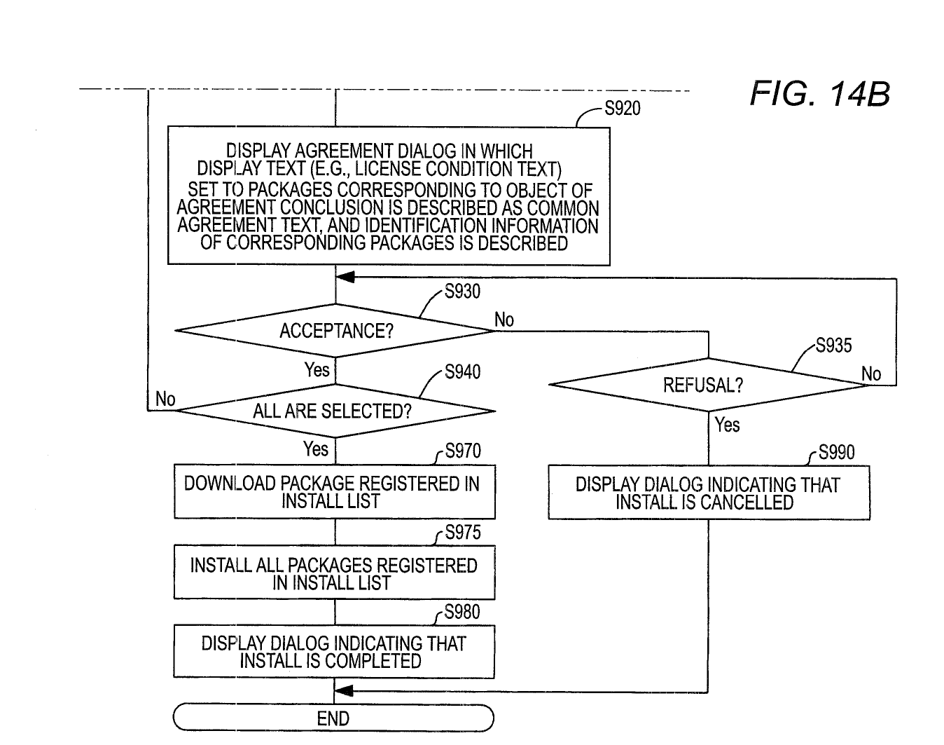

Then, the install control process in the fifth embodiment which is executed by the CPU 11 will be described with reference to FIGS. 13 and 14. FIGS. 13 and 14 are flowcharts showing the install control process in the fifth embodiment which is executed by the CPU 11.

When the install control process in the fifth embodiment is started, first, the CPU 11 registers the package which is designated in the installation execution instruction by the user, into the install list (S710), and obtains data showing the dependence relationship of the package which is designated in the installation execution instruction, from the server apparatus 40 in accordance with the repository set information (S720).

Based on the data showing the dependence relationship obtained from the server apparatus 40, a package(s) on which the package that is designated by the user in the installation execution instruction depends, and which is not installed in the apparatus is identified (S730).

In the case where it is found that there is not a package to be installed, the CPU 11 makes a negative determination in S735, and the process of the CPU goes to S810 without performing the processes of S740 to S790. In the case where there is a package to be installed, the CPU 11 makes an affirmative determination in S735, and then the process goes to S740 to register all of the packages to be installed which are identified in the process of S730, into the install list.

Thereafter, the CPU 11 selects one package which has not been checked for the dependence relationship, as a check target for a dependence relationship from the install list (S750), and obtains data showing the dependence relationship of the package which has not been checked for the dependence relationship, from the server apparatus 40 (S760).

Then, the CPU specifies a package on which the package that is a check target for the dependence relationship depends, and which is not installed in the apparatus (S770). In this case, the process is not applied to a package which has been already registered in the install list. Thereafter, the process of the CPU goes to S780, and executes processes similar to those of S180, S185, and S190 in the first embodiment, in S780, S785, and S790.

Namely, the CPU 11 executes the processes of S710 to S790 to, without downloading a package to be installed from the server apparatus 40, obtain only data indicating the dependence relationship corresponding to the package, and check packages which are directly or indirectly in a dependence relationship with the package that is designated in the installation execution instruction. Among the packages, then, all packages to be installed are registered in the install list.

When the process goes to S810, the CPU 11 executes processes similar to those of S210, S230, S270, and S290 in the first embodiment, in S810, S830, S870, and S890. In S830, however, an agreement text display setting process shown in FIG. 14 is executed in place of the agreement text display setting process shown in FIG. 6.

In the agreement text display setting process, the CPU obtains license information corresponding to the package which is an check target for the license condition, from the server apparatus 40 (S840), the license condition text indicated by the text data which are obtained as the license information is set as a display text in a license dialog corresponding to the package which is an check target for the license condition (S850), and the agreement text display setting process is ended.

When the agreement text display setting process of S830 is ended in this way and the license list is produced in S890, the process of the CPU 11 goes to S910, and executes processes similar to those of S310 to S340, in S910 to S940. If the CPU determines that all of the licenses registered in the license list are selected as an item subjected to agreement conclusion (Yes in S940), the process of the CPU goes to S970 to download the packages registered in the install list from the server apparatus 40. In S970, however, it is not required to download packages which are already held in a to-be-installed state by the information processing apparatus 10, from the server apparatus 40.

When the process of S970 is ended, the CPU 11 registers the packages registered in the install list, into the apparatus (S975). When the install is completed, the CPU executes a process similar to that of S380, in S980, and ends the install control process.

As described above, in the install control process in the embodiment, at a timing when the intention of conclusion of the license is input for all of the to-be-installed packages, the to-be-installed packages are downloaded from the server apparatus 40, and then installed into the information processing apparatus 10.

By contrast, when “Refusal” button in the license dialog is clicked (Yes in S935), the CPU 11 executes a process similar to that of S390, in S990, and ends the install control process.

The information processing apparatus 10 of the fifth embodiment has been described. According to the information processing apparatus 10, each of packages which are set as install items is downloaded from the server apparatus 40 which stores the package, after the intention of conclusion of the license for the package is input, and then installed. As in the first embodiment, when the intention of refusing the license is input, therefore, the package downloading operation which has been performed can be prevented from being wasted, and the convenience can be improved.

According to the embodiment, also when conclusion of the license is necessary in advance of downloading a package, the package can be downloaded from the server apparatus 40 without problems. In the above exemplary embodiments, the hard disk drive storing the program for installing an application software is employed as an example of the computer readable recording medium according to the invention. However, the computer readable recording medium according to the invention is not limited to the hard disk drive. The computer readable recording medium according to the invention may be any computer readable recording medium, such as an optical disk (CD-ROM, DVD-ROM, etc.), flash memory and the like, storing the program for installing an application software.

Correspondence Relationships with Claims

Although the embodiments of the invention have been described, the object set procedure set forth in “CLAIMS” is realized by the processes of S110 to S190 (the first to fourth embodiments) or S710 to S790 (the fifth embodiment) which are to be executed by the CPU 11 in the embodiments. Specifically, the procedure is realized by the operation of registering a package which is in a dependence relationship, into the install list.

The license identifying procedure is realized by the processes of S210, S230, and S270 (the first to fourth embodiments) or S810, S830, and S870 (the fifth embodiment) which are to be executed by the CPU 11. Specifically, the procedure is realized by the operation of setting the display text (agreement text) into the license dialog corresponding to the package.

The detection procedure is realized by the process of S290 (the first to fourth embodiments) or S890 (the fifth embodiment) which is to be executed by the CPU 11. Namely, the procedure is realized by the operation of dividing packages registered in the install list into groups each configured by packages having the same license, and registering the packages into the license list.

The display control procedure is realized by the processes of S310 to S365 (the first embodiment), S410 to S465 (the second embodiment), S510 to S565 (the third embodiment), S610 to S665 (the fourth embodiment), or S910 to S940 (the fifth embodiment) which are to be executed by the CPU 11.

The install procedure is realized by the process of S370 (the first embodiment), S470 (the second embodiment), S540 and S570 (the third embodiment), S670 (the fourth embodiment), or S970 to S975 (the fifth embodiment) which is to be executed by the CPU 11. The uninstall procedure is realized by the processes of S591 to S595 (the third embodiment) which are to be executed by the CPU 11.

Furthermore, the server apparatus which stores correspondence relationships between a software and the kind of a license that must be concluded in the use of the software corresponds to the server apparatus 40 which has license information for each package.

What is claimed is:

1. A computer readable recording medium storing a program for causing a computer to perform:
an install item setting procedure for setting plural pieces of software as install items;
an license identifying procedure for identifying a license that must be concluded in a use of the software with respect to each of the plural pieces of software which are set as the install items in the install item setting procedure;
a detection procedure for detecting a first software group including pieces of software having a first license to be concluded, from the plural pieces of software which are set as the install items;
a display control procedure for controlling a displaying device to display first agreement information of the first license that is common to the pieces of software in the first software group; and
an install procedure for installing the pieces of software in the first software group in which intention of conclusion is input from an outside.

2. The medium according to claim 1, wherein, when the pieces of software which are set as the install items include software which is not included in the first software group, the display control procedure controls the display device to display second agreement information of a second license of the piece of software which is set as the install item and is not included in the first software group.

3. The medium according to claim 2, wherein
the display control procedure controls the display device to display a first input object through which intention of concluding the license that is common to the software group can be input, and controls the display device to display a second input object through which intention of concluding the license of the software which is set as the install item and is not included in the detected software group can be input,
the install procedure installs the pieces of software corresponding to the license in which intention of conclusion is input through the input object.

4. The medium according to claim 2, wherein
the display control procedure controls the displaying device to display a collective input object through which intention of collectively concluding licenses of the pieces of software which are set as the install items can be input, and
the install procedure installs the pieces of software which are install items when the intention of collectively concluding licenses of the pieces of software is input through the collective input object.

5. The medium according to claim 3, wherein
the display control procedure controls the display to display an license screen in which the first agreement information is described, and which includes the first input object, and controls the display device to display an license screen in which the second agreement information is described and which includes the second input object.

6. The medium according to claim 4, wherein
the display control procedure controls the display device to display the collective input object on a license screen on which the first and second agreement information is described.

7. The medium according to claim 2, wherein
the install item setting procedure sets, when an installation execution instruction is input from an outside, the software which is instructed from the outside by the execution instruction, and a software which is necessary for executing the instructed software, as the install items.

8. The medium according to claim 7, wherein
the install procedure starts installing each of the pieces of software at a timing when intention of concluding the licenses of all pieces of software which are set as the install items in the install item setting procedure is input.

9. The medium according to claim 3, wherein
the install item setting procedure sets, when an installation execution instruction is input from an outside, the software which is instructed from the outside by the execution instruction, and software which is necessary for executing the instructed software, as the install items,
the install procedure sequentially installs the pieces of software which are set as the install items in the install item setting procedure, with starting from the software corresponding to the license in which the intention of concluding is input, and
the program further causes the computer to perform:
an uninstall procedure for, when intention of refusing the license is input from the outside with respect to any license, canceling the install of the pieces of software in the install procedure, and uninstalling all pieces of software which have been installed in the install procedure up to a timing of inputting the intention of refusal.

10. The medium according to claim 5, wherein
the install item setting procedure sets, when an installation execution instruction is input from an outside, the software which is instructed from the outside by the execution instruction, and software which is necessary for executing the instructed software, as the install item,
the install procedure sequentially installs the pieces of software which are set as the install items in the install item setting procedure, with starting from a software corresponding to the license in which intention of concluding is input through the input object,
the display control procedure controls the displaying device to display the license screen that further includes a refusal input object through which intention of refusing a license can be input, and
the program further causes the computer to perform:
an uninstall procedure for, when intention of refusing a license is input through the refusal input object, canceling the install of the pieces of software in the install procedure, and uninstalling all pieces of software which have been installed in the install procedure up to a timing of inputting the intention of refusal.

11. The medium according to claim 5, wherein
the display control procedure controls the displaying device not to display the license screen with respect to the software in which the license that must be concluded is a license of a specific kind, and controls the displaying device to display only the license screen with respect to a software in which the license that must be concluded is not the license of the specific kind, and
the install procedure assumes that intention of concluding the license with respect to the software in which the license that must be concluded is the license of the specific kind is input and installs the pieces of software.

12. The medium according to claim 2, wherein
the license identifying procedure obtains, from a server apparatus which stores correspondence relationships between a software and a kind of a license that must be concluded in a use of the software, information indicating a kind of the license that must be concluded in a use of each of the pieces of software which are set as the install items in the install item setting procedure, and identifies the license that must be concluded in a use of each of the pieces of software which are set as the install items, and
the install procedure downloads the pieces of software which are set as install items from a server apparatus which stores the pieces of software, after intention of concluding the license of the software is input, and installs the pieces of software.

13. The medium according to claim 2, wherein
the display control procedure controls the displaying device to display identification information of the software which is made usable by conclusion of the license while correlating with the agreement information of the license.

14. A computer readable recording medium storing a program for causing a computer to perform:
an install item setting procedure for setting plural pieces of software as install items;
a display control procedure for controlling a displaying device to display a license screen in which agreement information of a license that must be concluded in a use of each of the pieces of software that are set as the install items in the install item setting procedure is described, the license screen including a collective input object through which intention of collectively concluding licenses of the pieces of software can be input; and
an install procedure for installing the pieces of software which are set as the install items when the intention of collectively concluding licenses is input through the collective input object included in the license screen.

15. The medium according to claim 14, wherein
the install item setting procedure sets, when an installation execution instruction is input from an outside, the software which is instructed from the outside by the execution instruction, and a software which is necessary for executing the instructed software, as the install item.

16. The medium according to claim 14, wherein
the display control procedure controls the displaying device to display identification information of the software which is made usable by conclusion of the license while correlating with the agreement information of the license.

17. A method of installing plural pieces of software which are set as install items, into an information processing apparatus, the method comprising:
identifying a license that must be concluded in a use of the software with respect to each of the plural pieces of software which are set as the install items;
detecting a software group including pieces of software having the same license to be concluded, from the plural pieces of software which are set as the install items;
controlling a displaying device to display first agreement information of the license that is common to the pieces of software in the detected software group;
when the pieces of software which are set as the install item include the software which is not included in the detected software group, controlling the display device to display second agreement information of the license of the piece of software which is set as the install item and is not included in the detected software group; and
installing the pieces of software corresponding to the license in which intention of conclusion is input from an outside.

18. A method of installing plural pieces of software which are set as an install items, into an information processing apparatus, the method comprising:
controlling a displaying device to display a license screen in which agreement information of a license that must be concluded in a use of each of the pieces of software that are set as the install items is described, the license screen including a collective input object through which intention of collectively concluding licenses of the pieces of software can be input; and
installing the pieces of software which are set as the install items when the intention of collectively concluding licenses is input through the collective input object included in the license screen.

19. An information processing apparatus comprising:
an item setting unit which sets plural pieces of software as install items;
an agreement identifying unit which identifies a license that must be concluded in a use of the software with respect to each of the plural pieces of software which are set as the install items;
a detecting unit which detects a software group including pieces of software having the same license to be concluded, from the plural pieces of software which are set as the install items;
a display controlling unit which controls a displaying device to display first agreement information of the license that is common to the pieces of software in the detected software group, and when the pieces of software which is set as the install item includes the software which is not included in the detected software group, controls the display device to display second agreement information of the license of the piece of software which is set as the install item and is not included in the detected software group; and
an installing unit which installs the pieces of software corresponding to the license in which intention of conclusion is input from an outside in the information processing apparatus.

20. An information processing apparatus including:
an item setting unit which sets plural pieces of software as install items;
a display controlling unit which controls a displaying device to display a license screen in which agreement information of a license that must be concluded in a use of each of the pieces of software that are set as the install items is described, the license screen including a collective input object through which intention of collectively concluding licenses of the pieces of software can be input; and
an installing unit which installs the pieces of software which are set as the install items in the information processing apparatus when the intention of collectively concluding licenses is input through the collective input object included in the license screen.
